(19) United States
(12) Patent Application Publication
(10) Pub. No.: US 2026/0142416 A1
(43) Pub. Date: May 21, 2026

(54) CONNECTOR

(71) Applicant: SUMITOMO WIRING SYSTEMS, LTD., Mie (JP)

(72) Inventor: Takuma YONEZU, Mie (JP)

(21) Appl. No.: 19/377,866

(22) Filed: Nov. 3, 2025

(30) Foreign Application Priority Data
Nov. 15, 2024 (JP) 2024-199515

(51) Int. Cl. H01R 13/631

(52) U.S. Cl. CPC H01R 13/631

(57) ABSTRACT

A connector includes a housing and terminal fittings that are mounted to the housing. The terminal fittings each includes a substrate connection portion that extends in an up-down direction outside the housing and is connected to a substrate. The housing includes: a pair of the side walls disposed on opposite sides of the substrate connection portions in a left-right direction; and at least three substrate-side protrusions that protrude downward from the pair of side walls and are held by the substrate. On each of the pair of side walls, substrate-side protrusions protrude from two positions spaced apart from each other in a front-rear direction.

### CROSS-REFERENCE TO RELATED APPLICATIONS

This application is based on and claims priority from Japanese Patent Application No. 2024-199515, filed on November 15, 2024, with the Japan Patent Office, the disclosure of which is incorporated herein in its entirety by reference.

### TECHNICAL FIELD

The present disclosure relates to a connector.

### BACKGROUND

The connector disclosed in JP 2024-067892 A includes a plurality of terminals that are connected to a substrate. The connector is provided with locking portions disposed on opposite sides of terminals. The locking portions are inserted and locked into respective locking holes formed in the substrate.

### SUMMARY

In JP 2024-067892 A, the locking portions are arranged in a straight line in the left-right direction. For this reason, for example, when a partner connector is mated with the connector in a tilted manner in a direction oblique to a proper mating direction (hereinafter referred to as "twisted mating"), the locking portions cannot sufficiently resist the external force applied in the oblique direction, and there is a concern that, in the worst case, some of the locking portions may be broken, fractured, or otherwise damaged, thereby compromising the stability of the connector held on the substrate.

In view of this, an object of the present invention is to achieve a configuration in which a connector is stably held on a substrate even when the connector receives an external force.

A connector according to the present disclosure is a connector including: a housing; and terminal fittings that are mounted to the housing, wherein the terminal fittings each include a substrate connection portion that extends in an up-down direction outside the housing and is configured to be connected to a substrate, the housing includes: a pair of side walls disposed on opposite sides of the substrate connection portions in a left-right direction; and at least three substrate-side protrusions that protrude downward from the pair of side walls and are configured to be held by the substrate, and on at least one side wall out of the pair of side walls, substrate-side protrusions protrude from two or more positions spaced apart from each other in a front-rear direction.

The present disclosure can provide a connector that is stably held on a substrate.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a housing and terminal fittings of a connector according to a first embodiment as viewed from the lower rear lateral side.

FIG. 2 is a perspective view of the housing of the connector according to the first embodiment as viewed from the lower rear lateral side.

FIG. 3 is a perspective view of the housing of the connector according to the first embodiment as viewed from the upper rear lateral side.

FIG. 4 is an enlarged perspective view of substrate-side protrusions and a portion of a side wall of the connector according to the first embodiment.

FIG. 5 is a perspective view of two types of terminal fittings of the connector according to the first embodiment.

FIG. 6 is a side cross-sectional view of the connector according to the first embodiment.

FIG. 7 is a bottom view of a rear section of the connector according to the first embodiment, as viewed from below.

FIG. 8 is a perspective view of a pressing jig that is used to attach the connector according to the first embodiment to a substrate.

FIG. 9 is a rear view showing a state where the connector according to the first embodiment is attached to the substrate using the pressing jig.

FIG. 10 is an enlarged side view of a portion of the connector according to the first embodiment, in which substrate-side protrusions are held by the substrate and a case-side protrusion is held by a case.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### [Description of Embodiments of Present Disclosure]

First, embodiments of the present disclosure will be listed and described.

(1) A connector according to the present disclosure including: a housing; and terminal fittings that are mounted to the housing, wherein the terminal fittings each include a substrate connection portion that extends in an up-down direction outside the housing and is configured to be connected to a substrate, the housing includes: a pair of side walls disposed on opposite sides of the substrate connection portions in a left-right direction; and at least three substrate-side protrusions that protrude downward from the pair of side walls and are configured to be held by the substrate, and on at least one side wall out of the pair of side walls, substrate-side protrusions protrude from two or more positions spaced apart from each other in a front-rear direction.

With the configuration according to above (1), the substrate-side protrusions are arranged around the substrate connection portions over a large area extending in the front-rear and left-right directions, and thus, for example, even when a partner connector is mated with the connector in a twisted manner or the like, and an external force in an oblique direction acts on the connector, the substrate-side protrusions can effectively resist the external force. As a result, it is possible to avoid compromising the stability of the connector that is held on the substrate.

(2) In the connector according to above (1), preferably, leading ends of the substrate-side protrusions are positioned lower than leading ends of the substrate connection portions. With the configuration according to above (2), when attaching the connector to the substrate, it is possible to bring the substrate-side protrusions into contact with the substrate before the substrate connection portions do, and thereby determine the relative positions between the substrate and the substrate connection portions in the front-rear direction and the left-right direction before connecting the substrate connection portions to the substrate.

(3) In the connector according to above (1), preferably, each of the substrate-side protrusions has a circular outer peripheral shape as viewed from below, and a hole that extends in an up-down direction and is open in the leading end of the substrate-side protrusion is formed along an axial center of the substrate-side protrusion. With the configuration according to above (3), for example, when the substrate-side protrusions are brought into contact with the substrate in order to insert the substrate-side protrusions into the through holes of the substrate, the substrate-side protrusions can be uniformly compressed and deformed while decreasing the holes in size. As a result, it is possible to prevent the axes of the substrate-side protrusions from being misaligned with the axes of the through holes, and further increase the stability of the connector that is held on the substrate.

(4) In the connector according to above (1) to (3), preferably, the housing includes case-side protrusions that protrude upward from the pair of side walls and are configured to be held by a case. With the configuration according to above (4), the connector is also stably held on the case in addition to the substrate.

### [Details of Embodiments of the Present Disclosure]

Specific examples of the present disclosure will be described below with reference to the drawings. Note that the present invention is not limited to illustrations of these, but is indicated by the claims, and is intended to include all modifications that are within the meanings and the scope that are equivalent to those of the claims.

### <First Embodiment>

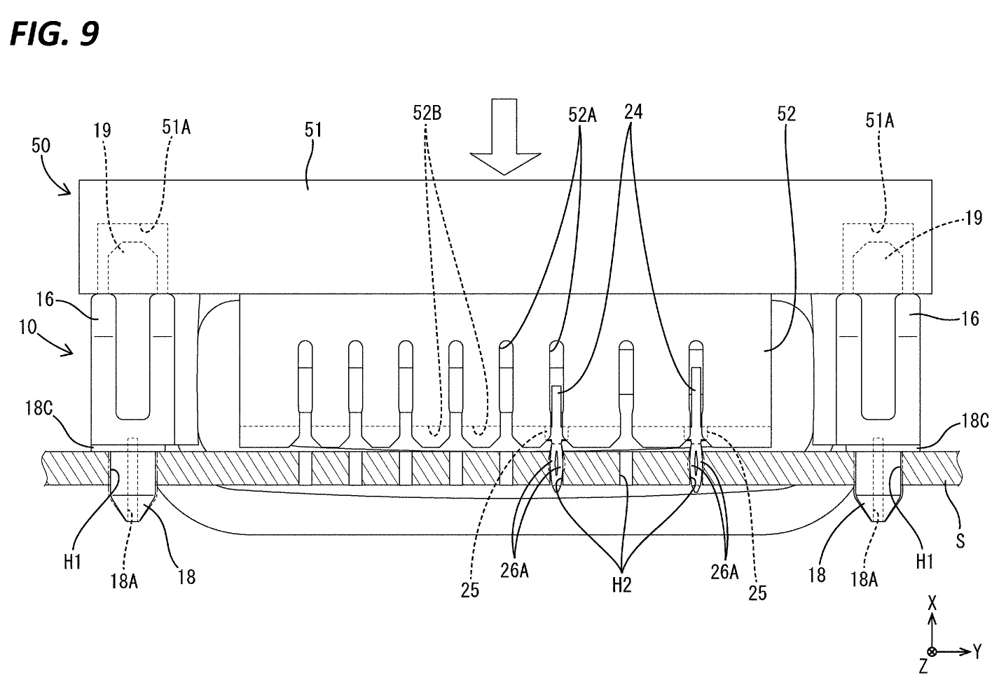

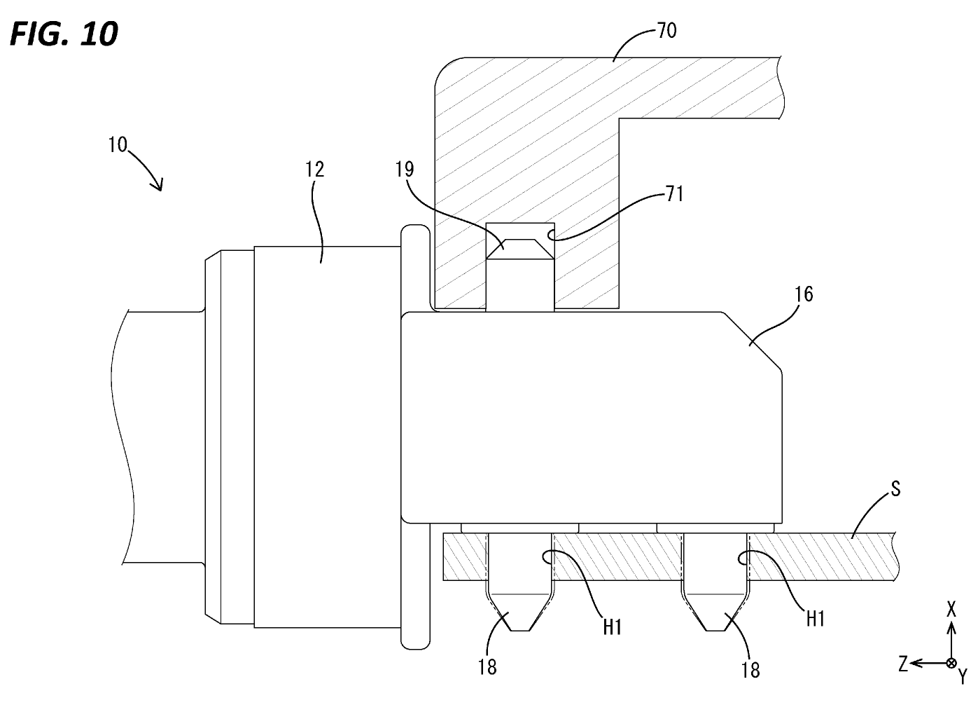

A connector 10 according to a first embodiment is attached to a substrate S such as a rigid printed circuit board (see FIGS. 9 and 10). Note that, in the following description, for convenience, the surface of the substrate S to which the connector 10 is attached is defined as an upper surface, and in the drawings, the upward, rightward, and forward directions are respectively indicated by reference signs X, Y, and Z. These reference directions do not necessarily coincide with the reference directions in a state where the connector 10 is mounted in a vehicle or the like (not shown). For example, the lower side in the present disclosure is not limited to the lower side of the gravity direction.

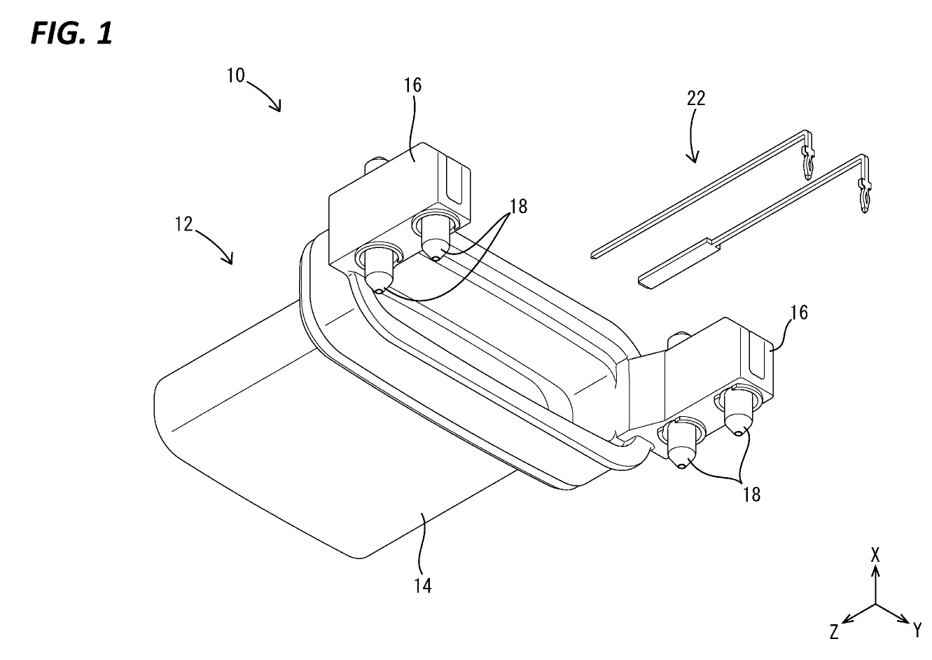

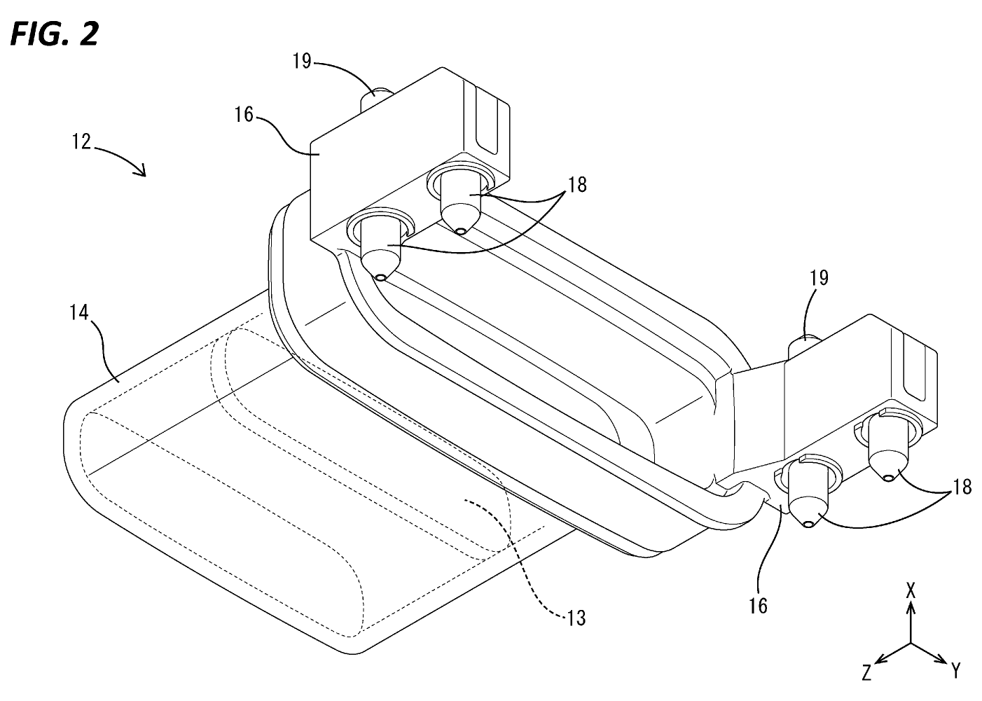

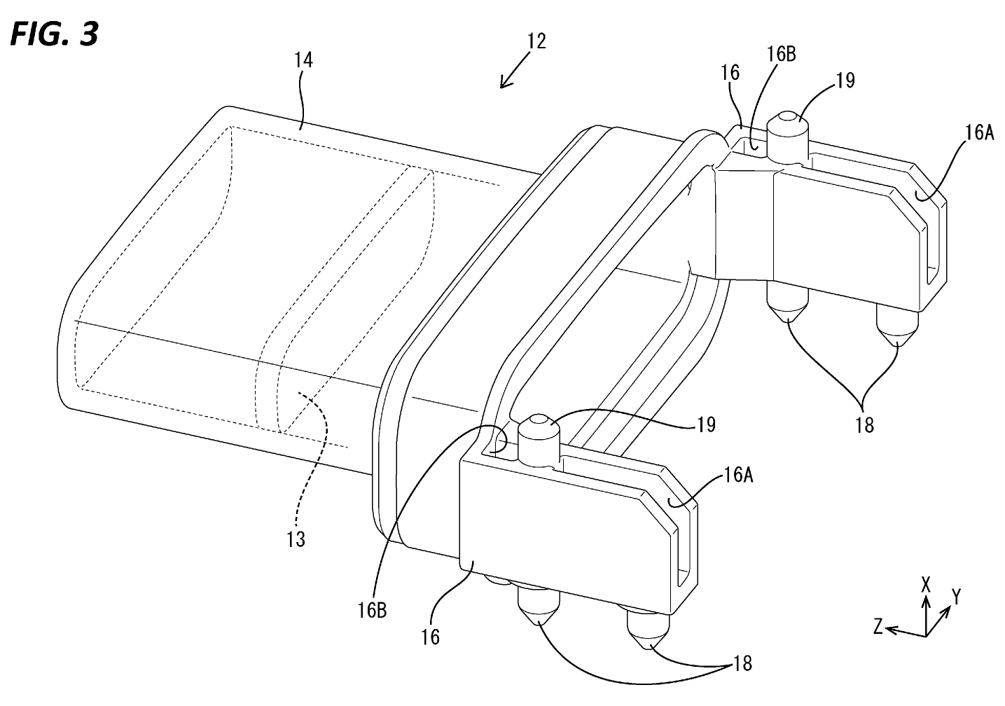

As shown in FIG. 1, the connector 10 includes a housing 12 and a plurality of terminal fittings 22 that are mounted to the housing 12. The housing 12 is made of a synthetic resin. As shown in FIGS. 2 and 3, the housing 12 includes a terminal holding portion 13, a hood portion 14, a pair of side walls 16 that form a pair in the left-right direction, at least three or more substrate-side protrusions 18, and a pair of case-side protrusions 19. The terminal holding portion 13 has a wall shape and has a wall thickness directed in the front-rear direction. The hood portion 14 has a tubular shape, specifically, a flat tubular shape that is longer in the left-right direction than in the up-down direction. The terminal holding portion 13 is disposed inside the hood portion 14 and divides the interior of the hood portion 14 in the front-rear direction.

The pair of side walls 16 have a wall shape and have a wall thickness directed in the left-right direction. The side walls 16 protrude rearward from the two end portions in the left-right direction of the rear end edge of the hood portion 14. A weight-reduction groove 16A that is open upward and rearward is formed in each of the side walls 16.

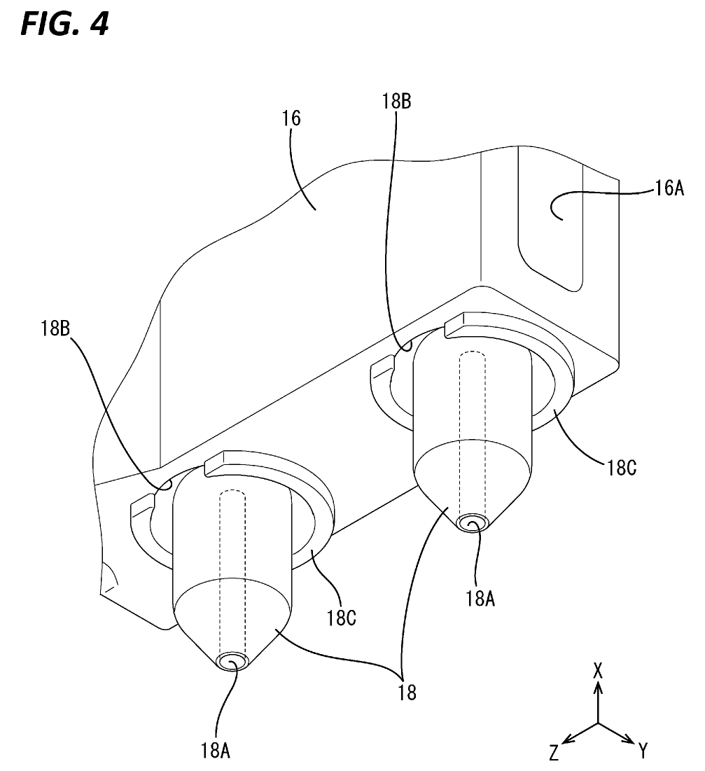

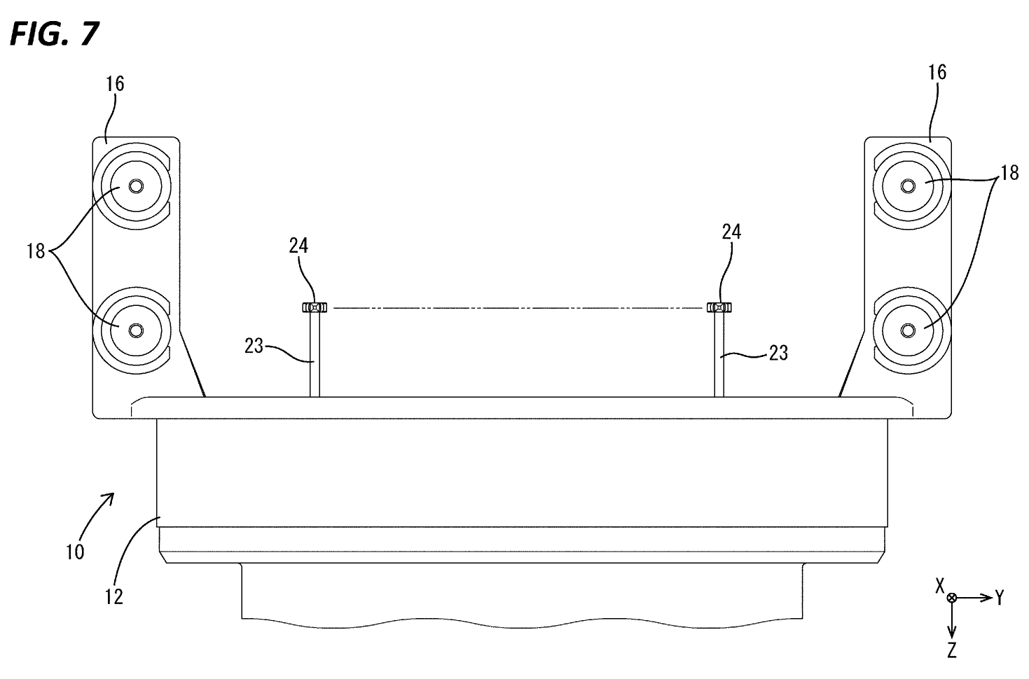

In the first embodiment, two substrate-side protrusions 18 are provided on each of the side walls 16, thus making the total number of substrate-side protrusions 18 four. The substrate-side protrusions 18 protrude downward from the lower end surfaces of the pair of side walls 16. The substrate-side protrusions 18 each have a columnar or cylindrical shape with a tapered tip, and have a circular outer peripheral shape as viewed from below (see FIG. 7). As shown in FIG. 4, holes 18A are formed along the axial centers of the substrate-side protrusions 18. The holes 18A extend in the up-down direction within the substrate-side protrusions 18, and are open in the leading ends (lower ends) of the substrate-side protrusions 18. The rear ends of the holes 18A are positioned at the lower end portions of the side walls 16. The holes 18A are not connected to the weight-reduction grooves 16A. The lower end portions of the substrate-side protrusions 18 are each formed in a tapered shape such that the entire circumference thereof decreases in diameter toward the tip. On one of the side walls 16, the substrate-side protrusions 18 protrude from two positions spaced apart from each other in the front-rear direction.

In the lower end surface of each of the side walls 16, annular recessed portions 18B that respectively surround the base portions of the substrate-side protrusions 18 over the entire circumferences thereof are formed in a recessed manner. In addition, on the lower end surface of the side wall 16, protruded portions 18C having a C-shape as viewed from below and partially surrounding the circumferences of the recessed portions 18B, respectively, are also formed. The lower ends of the protruded portions 18C are formed as planes parallel to the lower end surface of the side wall 16. The substrate-side protrusions 18 are inserted (press-fitted) into respective through holes H1 of the substrate S (see FIG. 9). By being press-fitted into the through holes H1, the substrate-side protrusions 18 are held by (fixed to) the substrate S. The lower ends of the protruded portions 18C are placed on the upper surface of the substrate S.

As shown in FIG. 3, the case-side protrusions 19 are formed in a circular shape and protrude upward respectively from the pair of side walls 16. The diameter of case-side protrusions 19 is the same as that of the substrate-side protrusions 18. The upper end portion of each case-side protrusion 19 is formed in a tapered shape that decreases in diameter toward the leading end thereof. The case-side protrusion 19 is disposed coaxially in the up-down direction with the substrate-side protrusion 18 on the front side out of the two substrate-side protrusions 18 aligned in the front-rear direction. The case-side protrusion 19 is solid and has no hole formed therein. In an area of the side wall 16 that is located forward of the case-side protrusion 19, a weight-reduction hole 16B that is open upward is formed.

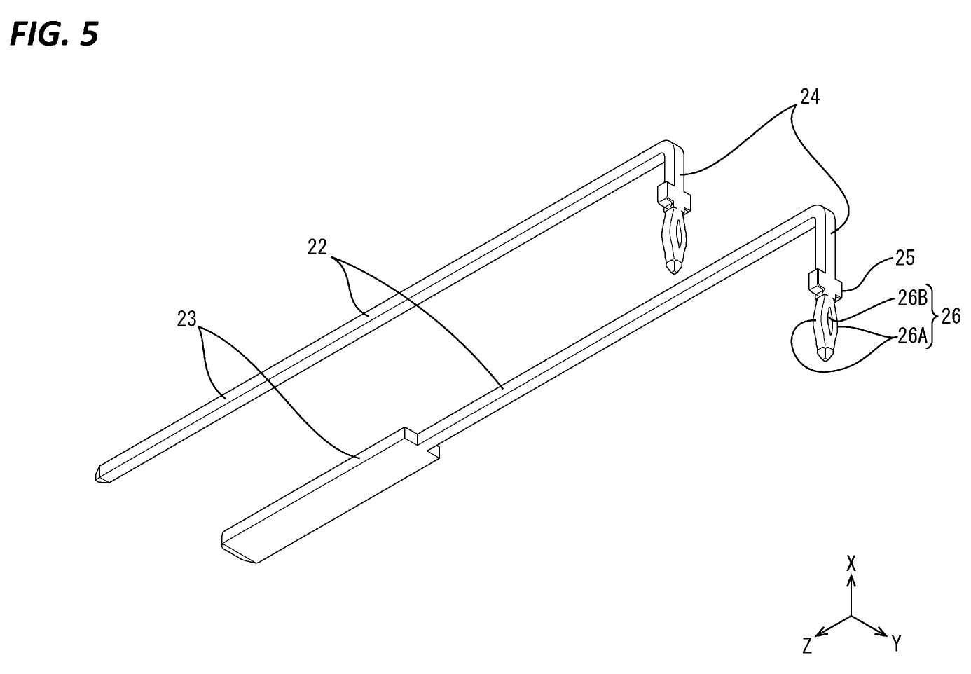

The terminal fittings 22 are each formed by bending an elongated metal material into an L-shape. The terminal fittings 22 are male terminal fittings. As shown in FIG. 5, the terminal fittings 22 each include an extended portion 23 that extends in the front-rear direction, and a substrate connection portion 24 that extends in the up-down direction after being bent perpendicularly downward from the rear end of the extended portion 23. In some of the terminal fittings 22 (the terminal fitting 22 on the right in FIG. 5), the extended portion 23 includes a portion that is formed to have a greater width than the extended portions 23 of the other terminal fittings 22 (the terminal fitting 22 on the left in FIG. 5). A rectangular portion 25 and a press-fit portion 26 are provided at the lower end portion of the substrate connection portion 24. The rectangular portion 25 protrudes outward laterally in a rectangular shape from the main body of the substrate connection portion 24.

The press-fit portion 26 is positioned at the lower end portion (leading end portion) of the substrate connection portion 24, and is provided continuously with the lower end of the rectangular portion 25. In the press-fit portion 26, a pair of elastic contact pieces 26A and a flexure space 26B disposed between the pair of elastic contact pieces 26A are formed. The pair of elastic contact pieces 26A protrude to be spaced apart from each other in the left-right direction. The pair of elastic contact pieces 26A are elastically deformable in the left-right direction so as to narrow the flexure space 26B.

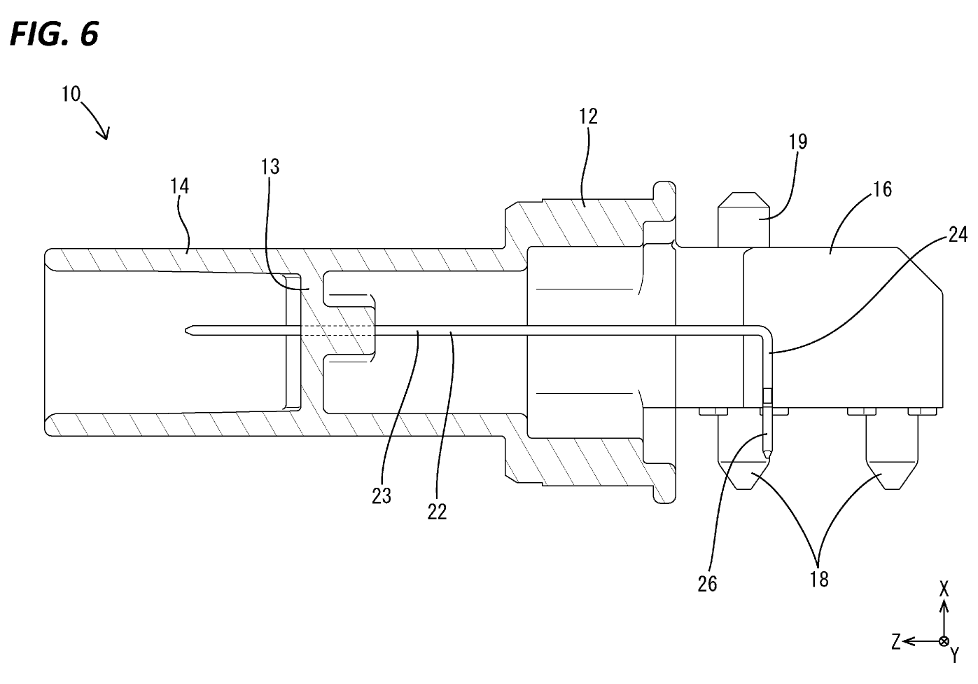

As shown in FIG. 6, each terminal fitting 22 is fixed to the terminal holding portion 13 in a state where the extended portion 23 extends through the terminal holding portion 13 in the front-rear direction. In a state where a plurality of terminal fittings 22 are attached and fixed to the housing 12, the extended portions 23 are arranged in parallel to each other (see FIG. 7), and the substrate connection portions 24 are arranged in parallel to each other (see FIG. 9). The front end portions of the extended portions 23 protrude into the hood portion 14, which extends forward from the front surface of the terminal holding portion 13.

As shown in FIG. 7, the rear end portions of the extended portions 23 and the entirety of the substrate connection portions 24 are arranged between the pair of side walls 16 and are exposed. When viewed from the up-down direction, the substrate-side protrusions 18 are arranged around an area in which the plurality of substrate connection portions 24 are disposed. In other words, the substrate-side protrusions 18 extend downward on opposite sides of the substrate connection portions 24 in the left-right direction. The pair of side walls 16 are disposed on opposite sides of the plurality of substrate connection portions 24 in the left-right direction. The leading end portions (lower end portions) of the press-fit portions 26 of the substrate connection portions 24 protrude downward beyond the lower end edges of the side walls 16 (see FIGS. 6 and 9). The leading ends (lower ends) of the substrate-side protrusions 18 are positioned below the leading ends (lower ends) of the substrate connection portions 24 (see FIGS. 6 and 9). The connector 10 is formed in this manner.

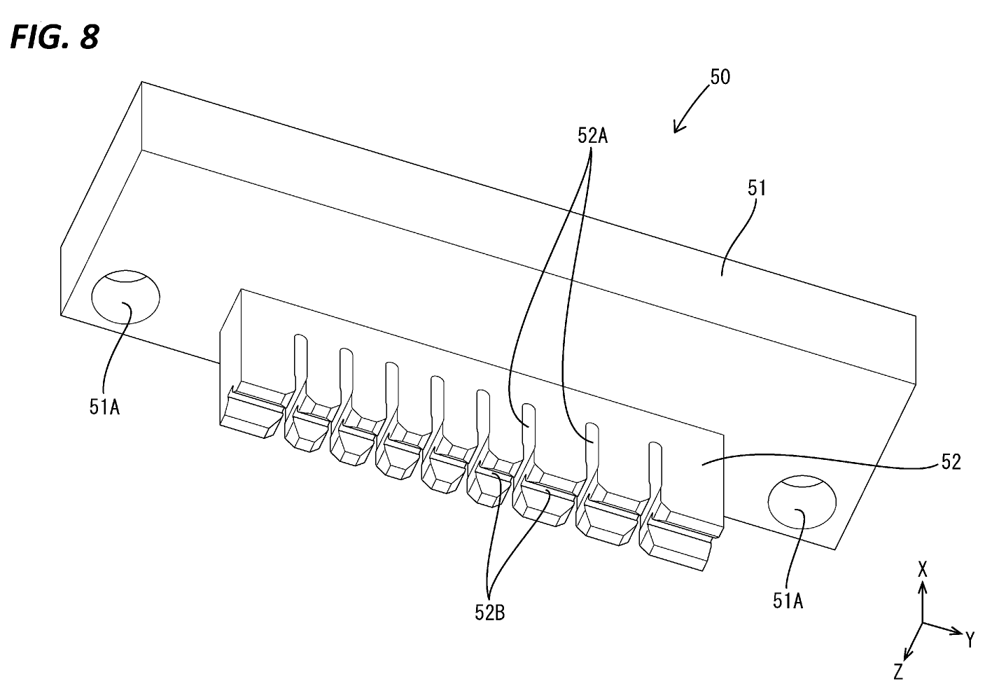

The substrate S, to which the connector 10 is attached, has a plurality of through holes H1 and H2 formed to extend therethrough in the thickness direction (see FIG. 9). When attaching the connector 10 to the substrate S, a pressing jig 50 shown in FIG. 8 is used. The pressing jig 50 is used to press-fit the substrate-side protrusions 18 into the through holes H1 and to press the press-fit portions 26 into the through holes H2.

The pressing jig 50 includes a block-shaped base portion 51 that is elongated in the left-right direction, and a pressing main body portion 52 that protrudes downward from the base portion 51. Upwardly recessed insertion holes 51A are respectively formed in the end portions in the left-right direction of the base portion 51.

The pressing main body portion 52 is formed in a block shape elongated in the left-right direction. A plurality of relief grooves 52A and a plurality of pressing grooves 52B are formed in the pressing main body portion 52. The relief grooves 52A are formed to be recessed from the lower end of the pressing main body portion 52. The relief grooves 52A are formed to extend in the front-rear direction with respect to the pressing main body portion 52. The relief grooves 52A are arranged in the left-right direction with respect to the pressing main body portion 52.

The pressing grooves 52B are formed to be recessed from the lower end of the pressing main body portion 52. The pressing grooves 52B extends in the left-right direction with respect to the pressing main body portion 52. The pressing grooves 52B are arranged in a straight line in the left-right direction. The upper ends (back ends) of the pressing grooves 52B are positioned below the upper ends (back ends) of the relief grooves 52A (see FIG. 9). That is to say, the pressing grooves 52B are formed to be shallower than the relief grooves 52A. The pressing jig 50 is formed in this manner.

An example of the procedure for attaching the connector 10 to the substrate S will be described. As shown in FIG. 9, first, the pressing jig 50 is installed on the connector 10. Specifically, the pressing jig 50 is oriented such that the pressing main body portion 52 protrudes downward from the base portion 51, and the pressing jig 50 is brought close to the connector 10 from above. Then, the substrate connection portions 24 of the terminal fittings 22 enter the respective relief grooves 52A from below. Along with this, the case-side protrusions 19 enter the respective insertion holes 51A from below.

When the pressing jig 50 is further brought close to the connector 10 from above, the rectangular portions 25 enter the respective pressing grooves 52B from below. Then, when the base portion 51 comes into contact with the upper ends of the pair of side walls 16 from above, the upper end edges of the rectangular portions 25 come into contact with the upper ends (back ends) of the respective pressing grooves 52B. In this manner, installation of the pressing jig 50 on the connector 10 is completed.

When attaching the connector 10 to the substrate S, the substrate-side protrusions 18 are aligned with the respective through hole H1. At this time, outside the housing 12, the substrate connection portions 24 extend in the up-down direction toward the substrate S. When the connector 10 is brought close to the substrate S from above while maintaining this posture, the substrate-side protrusions 18 are first inserted into the respective through holes H1 from above. Accordingly, the relative position of the housing 12 with respect to the substrate S in the front-rear and left-right directions is determined.

The diameter of the substrate-side protrusions 18 is larger than the internal diameter of the through holes H1. For this reason, by pressing the base portion 51 of the pressing jig 50 downward, the substrate-side protrusions 18 are press-fitted into the respective through holes H1 while reducing the holes 18A in size. The outer circumferential surfaces of the substrate-side protrusions 18 are compressed by the through holes H1 in such a manner as to reduce the diameters of the substrate-side protrusions 18, and thereby come into intimate contact with the inner circumferential surfaces of the through holes H1, respectively. Accordingly, the substrate-side protrusions 18 are fixed to the substrate S, thereby maintaining a state in which the housing 12 is attached to the substrate S.

In a state where the connector 10 is positioned on the substrate S as a result of press-fitting the substrate-side protrusions 18 into the through holes H1, the press-fit portions 26 are respectively inserted into the through holes H2 from above. As each press-fit portion 26 is inserted into a corresponding through hole H2, the pair of elastic contact pieces 26A elastically deform toward each other. Accordingly, the elastic contact pieces 26A come into elastic contact with the inner circumferential surface of the through hole H2. In this manner, the substrate connection portions 24 are connected to the substrate S. The protruded portions 18C formed on the lower ends of the respective side walls 16 then come into contact with the upper surface of the substrate S from above, thereby completing the attachment of the connector 10 to the substrate S. The pressing jig 50 is then removed from the connector 10. At this time, the pressing jig 50 can be smoothly removed from the connector 10 since a gap is formed between each insertion hole 51A and the corresponding case-side protrusion 19.

As shown in FIG. 10, after the connector 10 is attached to the substrate S and the pressing jig 50 is removed, a metal case 70, which serves as a housing for an ECU or the like, is attached to cover the side walls 16 from above. Mating holes 71 are formed in the case 70. When the case 70 is attached to the substrate S, the case-side protrusions 19 are fitted into the respective mating holes 71. Accordingly, the side walls 16 of the connector 10 are sandwiched between the substrate S and the case 70 in the up-down direction. As a result, even when a partner connector (not shown) is mated with the connector 10 in a twisted manner from a direction different from a proper mating direction, it is possible to suppress displacement of the connector 10 relative to the substrate S, and hold the connection between the press-fit portions 26 and the through holes H2 (see FIG. 9).

As described above, the connector 10 according to the first embodiment includes the housing 12 and the terminal fittings 22 that are mounted to the housing 12. The terminal fittings 22 each include a substrate connection portion 24 that extends in the up-down direction outside the housing 12 and is connected to the substrate S. The housing 12 includes the pair of side walls 16 that are disposed on opposite sides of the substrate connection portions 24 in the left-right direction, and the substrate-side protrusions 18 that protrude downward from the side walls 16 are held by the substrate S. The pair of side walls 16 each include the substrate-side protrusions 18 that protrude from two positions spaced apart from each other in the front-rear direction.

Accordingly, the substrate-side protrusions 18 can come into contact with the substrate S over a larger area extending in the front-rear and the left-right directions than in the case where the substrate-side protrusions 18 are arranged in a straight line in the left-right direction. For this reason, when an external force is applied to the housing 12, it is possible to prevent the attachment posture and position of the housing 12 relative to the substrate S from becoming unstable.

In addition, the leading ends of the substrate-side protrusions 18 are positioned lower than the leading ends of the substrate connection portions 24. Accordingly, when attaching the connector 10 to the substrate S, it is possible to bring the substrate-side protrusions 18 into contact with the substrate S before the substrate connection portions 24 do, and to determine the relative positions between the substrate S and the substrate connection portions 24 in the front-rear and the left-right directions before connecting the substrate connection portions 24 to the substrate S. As a result, the substrate connection portions 24 are smoothly inserted into the through holes H2, respectively.

In addition, each substrate-side protrusion 18 has a circular outer peripheral shape as viewed from below, and a hole 18A that extends in the up-down direction and is open in the leading end of the substrate-side protrusion 18 is formed along the axial center of the substrate-side protrusion 18. Accordingly, when the substrate-side protrusion 18 is press-fitted into a corresponding through hole H1 of the substrate S, the hole 18A enables the substrate-side protrusion 18 to be compressed uniformly in the radial direction over the entire circumference. As a result, the substrate-side protrusion 18 can be press-fitted into the through hole H1 such that the axis of the substrate-side protrusion 18 does not deviate from the axis of the through hole H1.

In addition, the housing 12 includes the case-side protrusions 19 that protrude upward from the pair of side walls 16 and are fixed to the case 70. Accordingly, the side walls 16 of the housing 12 can be joined to the substrate S and the case 70 such that the side walls 16 are sandwiched between the substrate S and the case 70.

### [Other Embodiments of Present Disclosure]

The first embodiment disclosed here is exemplary in all respects and should not be interpreted as limiting in any manner.

In the first embodiment above, the recessed portions are formed to surround the respective substrate-side protrusions. In contrast, according to another embodiment, only the protruded portions may be provided without forming the recessed portions.

In the first embodiment above, the leading ends of all the substrate-side protrusions are positioned lower than the leading ends of the substrate connection portions. In contrast, according to another embodiment, a configuration can be adopted in which the leading end of one of the substrate-side protrusions provided on each of the pair of side walls is positioned lower than the leading ends of the substrate connection portions. That is to say, a configuration may be adopted in which the leading ends of some of the substrate-side protrusions are positioned lower than the leading ends of the substrate connection portions.

In the first embodiment above, the substrate-side protrusions have a circular outer peripheral shape. In contrast, according to another embodiment, the substrate-side protrusions may have an outer peripheral shape such as a polygonal shape or an elliptical shape.

In the first embodiment above, a configuration is adopted in which the substrate-side protrusions are respectively press-fitted into the through holes of the substrate. In contrast, according to another embodiment, a configuration may be adopted in which the substrate-side protrusions are formed in a so-called snap-fit structure, in which the substrate-side protrusions elasticity deform so as to laterally embrace the two side edges of the substrate.

In the first embodiment above, the case-side protrusions are provided on the side walls. In contrast, according to another embodiment, a configuration may be adopted in which the case-side protrusion are provided on the rear end edge portion of the hood portion.

In the first embodiment above, the total number of substrate-side protrusions is four. In contrast, according to another embodiment, the total number of substrate-side protrusions may be three or five or more. If the total number of substrate-side protrusions is three, a configuration is preferably adopted in which two substrate-side protrusions are provided on one of the side walls, and one substrate-side protrusion is provided on the other side wall. Alternatively, if the total of substrate-side protrusions is four, a configuration may be adopted in which, on one of the side walls, substrate-side protrusions protrude from three positions spaced apart from each other in the front-rear direction, and, on the other side wall, one substrate-side protrusion protrudes from a single position. That is to say, a configuration is preferably adopted in which, on at least one of the pair of side walls, substrate-side protrusions protrude from two or more positions spaced apart from each other in the front-rear direction.

In the first embodiment above, the case-side protrusions are disposed coaxially with the substrate-side protrusions, and the diameter of the case-side protrusions is the same as that of the substrate-side protrusions. In contrast, according to another embodiment, the case-side protrusions may be disposed non-coaxially with the substrate-side protrusions, and the diameter of the case-side protrusions may be different from that of the substrate-side protrusions.

In the first embodiment above, a configuration is adopted in which a hole is formed in each substrate-side protrusion. In contrast, according to another embodiment, one or more slits may be formed so as to divide the substrate-side protrusion in a circumferential direction into two or four segments. In this case, preferably, at the protruding end portion of the substrate-side protrusion, a large-diameter portion having a larger diameter than that of the base end portion is provided. When the substrate-side protrusion is inserted into the through hole, the large-diameter portion is locked into the through hole and exerts a retaining effect that prevents it from coming loose.

In the first embodiment above, a configuration that includes case-side protrusions is adopted. In contrast, according to another embodiment, a configuration that includes no case-side protrusion may be adopted.

In the first embodiment above, the terminal fittings are male terminal fittings. In contrast, according to another embodiment, the terminal fittings may be female terminal fittings each having a box-shaped portion. In this case, cavities capable of accommodating the female terminal fittings may be formed in the terminal holding portion.

In the first embodiment above, each terminal fitting is bent into an L-shape. In contrast, according to another embodiment, the terminal fitting may have an overall shape extending linearly in the up-down direction. If the terminal fitting has such a linear shape, it is preferable that the hood portion is shaped to have the mating surface thereof being open upward and the side walls protruding downward from the lower end thereof.

In the first embodiment above, the terminal fittings are press-fit terminals each having an elastically deformable press-fit portion. In contrast, according to another embodiment, the terminal fittings may be configured to be fixed to the substrate by soldering instead of having press-fit portions.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a housing; and
terminal fittings that are mounted to the housing,
wherein the terminal fittings each include a substrate connection portion that extends in an up-down direction outside the housing and is configured to be connected to a substrate,
the housing includes:
a pair of side walls disposed on opposite sides of the substrate connection portions in a left-right direction; and
at least three substrate-side protrusions that protrude downward from the pair of side walls and are configured to be held by the substrate, and
on at least one side wall out of the pair of side walls, substrate-side protrusions protrude from two or more positions spaced apart from each other in a front-rear direction.

2. The connector according to claim 1,
wherein leading ends of the substrate-side protrusions are positioned lower than leading ends of the substrate connection portions.

3. The connector according to claim 1,
wherein each of the substrate-side protrusions has a circular outer peripheral shape as viewed from below, and
a hole that extends in an up-down direction and is open in the leading end of the substrate-side protrusion is formed along an axial center of the substrate-side protrusion.

4. The connector according to claim 1,
wherein the housing includes case-side protrusions that protrude upward from the pair of side walls and are configured to be held by a case.
